(19) United States
(12) Patent Application Publication
(10) Pub. No.: US 2026/0005895 A1
(43) Pub. Date: Jan. 1, 2026

(54) VERIFICATION UNIT AND METHOD FOR LOCATION VERIFICATION OF INSTALLED CABIN DEVICES IN AN AIRCRAFT SINGLE PAIR ETHERNET NETWORK

(71) Applicant: Airbus Operations GmbH, HAMBURG (DE)

(72) Inventors: Burkhard HEINKE, HAMBURG (DE); Christoph TILLACK-NIEVELER, HAMBURG (DE); Leo KRÜGER, HAMBURG (DE)

(21) Appl. No.: 19/250,753

(22) Filed: Jun. 26, 2025

(30) Foreign Application Priority Data
Jun. 28, 2024 (EP) 24185407.4

(51) Int. Cl. H04L 12/40; H04L 41/12

(52) U.S. Cl. CPC H04L 12/40019; H04L 41/12; H04L 2012/4028

(57) ABSTRACT

A verification unit for location verification of installed cabin devices in an aircraft single pair ethernet network. This verification unit comprises a computer with a program configured to provide a multidrop network architecture for connecting a plurality of installed cabin devices in an aircraft to the computer. The computer is further configured to verify a respective location of the installed cabin devices in an aircraft depending on a comparison based on a configuration list of the installed cabin devices in the aircraft stored in the computer program and at least one connection routine of the multidrop network architecture. Also a corresponding method.

### CROSS-REFERENCES TO RELATED APPLICATIONS

This application claims the benefit of European Patent Application Number 24185407.4 filed on Jun. 28, 2024, the entire disclosure of which is incorporated herein by way of reference.

### FIELD OF THE INVENTION

The present invention pertains to a verification unit and method for location verification of installed cabin devices in an aircraft single pair ethernet network.

### BACKGROUND OF THE INVENTION

Modern aircraft are equipped with numerous cabin devices that are functionally connected and coupled with each other and with at least one higher-level control unit. The installed cabin devices are not only checked for their actual function in relation to a specific purpose at the end of an assembly, but also for their functionality in relation to their location in the associated network. The focus here is on the correct installation position as well as their correct coupling or networking.

An exclusively manual approach to these complex quality routines has increasingly proven to be too costly. Traditional methods in this technical field like the use of DIP switches already provide initial approaches to automation, although the results obtained could be further improved in the future.

In parallel, approaches are being developed that use multidrop networks to enable appropriate networking of cabin devices within the aircraft, for example in the cabin itself as well as in the cockpit or in the cargo area.

The use of a multidrop network requires a clear identification of the network participants via their installation location. Up to now, manual settings have been used on aircraft for the clear identification of devices in networks, e.g., bus networks (pin programming). The time required for this task is accompanied by correspondingly high costs. These costs can arise especially when human work steps in particular have to be checked more closely in order to achieve a particularly high level of accuracy.

### SUMMARY OF THE INVENTION

Against this background, it is an object of the present invention to provide a cost-effective technical solution for verifying a correct location of network participants in complex SPE multi networks in aircraft.

This object may be achieved by a verification unit for location verification of installed cabin devices in an aircraft single pair ethernet network having the features of one or more embodiments described herein and a method for location verification of installed cabin devices in an aircraft single pair ethernet network having the features of one or more embodiments described herein.

According to the invention, a verification unit for location verification of installed cabin devices in an aircraft single pair ethernet network comprises a computer unit with computer program configured to provide a multidrop network architecture for connecting a plurality of installed cabin devices in an aircraft to the computer unit with computer program wherein the computer unit with computer program is further configured to verify a respective location of the installed cabin devices in an aircraft depending on a comparison based on a configuration list of the installed cabin devices in the aircraft stored in the computer program and at least one connection routine of the multidrop network architecture.

Further according to the invention, a method for location verification of installed cabin devices in an aircraft single pair ethernet network comprising the following steps: providing and activating a verification unit according to the invention, creating and storing a configuration list of installed cabin devices in an aircraft on the computer program of the verification unit, performing a comparison based on the configuration list of the installed cabin devices in the aircraft stored in the computer program and at least one connection routine of the multidrop network architecture of the verification unit, outputting results of the comparison performed so that a respective location of the installed cabin devices in the aircraft can be verified.

Further according to the invention, an aircraft comprises a verification unit according to the invention and at least one installed cabin device connected to the verification unit via a multidrop network architecture of the verification unit.

Thus, one idea of the present invention is to provide an efficient an robust installation solution for an installation of multidrop networks on aircraft. The presented invention can be seen as a comprehensive onboard network solution that supports autolocation in a multidrop network.

This new way of verifying locations of multidrop network participants minimizes installation errors because it represents a very reliable and cost-effective technical solution for verifying a correct location of network participants in complex multi networks in aircraft. It can be seen as a cost-effective technical solution because it saves installation time.

Instead of a manual setting, the presented invention favors an automatic solution based on a comparison of known facts, which are provided by means of a configuration list, with collected facts, which can be determined during the installation itself.

Further advantages can be seen in the fact that the presented unit and the inventive methodology is flexible for short-term changes to line replaceable unit positions or replacement of devices in the final assembly line.

The multidrop network architecture of the verification unit can comprise any technical means that are necessary to establish a corresponding multidrop network between the computer unit and the respective cabin devices. This includes in particular any components that are required in the sense of necessary interfaces to the respective technical participants in order to establish a sequentially constructed multidrop network.

The cabin devices can, for example, be respective line replaceable units or corresponding lighting devices in the cabin as well as in the cockpit or in the cargo area.

The aforementioned advantages of the present inventions, to the extent that they are transferable, also apply to the disclosed method and the disclosed aircraft.

According to an embodiment of the invention, the at least one connection routine of the multidrop network architecture comprises an evaluation of the temporal transmission rate of transmission signals from the installed cabin devices to the computer unit.

The respective values of the individual temporal transmission rates of transmission signals from the installed cabin devices to the computer unit thus allow a spatial classification of the connected cabin devices, whereby a higher value is correspondingly associated with a more distant localization. In this respect, a verification of already actively connected cabin devices can be derived by means of the comparison and the already known values from the configurations list.

According to another embodiment of the invention, the configuration list comprises information about the installed order or respective cable lengths of the respective cables between the respective installed cabin device and the computer unit.

The individual temporal transmission rates of transmission signals (measured times) from the installed cabin devices to the computer unit reflect the respective distances of wire length to the installed cabin devices (network participants). In conjunction with further information from the configurations list, precise local locations of the respective participants can be determined, so that corresponding statements about actively connected participants can be made.

In this context, it can advantageously if the respective cable connections or the cables themselves or the respective relevant cable sections between the computer unit and the respective cabin devices have at least a minimal length so that the measurement times can be determined in a reliable way.

A sufficient distinguishability of the individual lengths mentioned above can also be advantageously in order to enable a more precise assignment of the measured times to the information held in the configuration list.

According to another embodiment of the invention, the computer unit with computer program is configured to provide at least one alarm routine depending on at least one result of the comparison.

A user-friendly evaluation can thus be ensured, so that in the event of detected faulty connections or corresponding technical connection problems, an assignment to the affected cabin device can be provided very quickly.

In some embodiments of the invention, the multidrop network architecture comprises at least one Single-Pair Ethernet, SPE, communication link for connecting the installed cabin devices in the aircraft to the computer unit. Stable and reliable connections can thus be provided so that the multidrop network architecture of the verification unit can be advantageously supported. These SPE communication links can be based, for example, on the Single Pair Ethernet 10Base-TIs IEEE 802.3cg standard.

According to another embodiment of the invention, the connection routine of the multidrop network architecture used in the inventive method comprises an evaluation step of the temporal transmission rate of transmission signals from the installed cabin devices to the computer unit.

The respective values of the individual temporal transmission rates of transmission signals from the installed cabin devices to the computer unit thus allow a spatial classification of the connected cabin devices, whereby a higher value is correspondingly associated with a more distant localization. In this respect, a verification of already actively connected cabin devices can be derived by means of the comparison and the already known values from the configurations list.

According to another embodiment of the invention, the configuration list comprises information about the installed order or respective cable lengths of the respective cables between the respective installed cabin devices and the computer unit.

As previously mentioned, it can be of advantaged if the respective cable connections or the cables themselves or the respective relevant cable sections between the computer unit and the respective cabin devices have at least a minimal length so that the measurement times can be determined in a reliable way.

A sufficient distinguishability of the individual lengths mentioned above can also be advantageously in order to enable a more precise assignment of the measured times to the information held in the configuration list.

According to another embodiment of the invention, the creating of the configuration list of the installed cabin devices in the aircraft is carried out by using additional tools, in particular QR readers.

This means that at least an initial inspection of the cabin devices to be connected can be carried out. In conjunction with the verification routine or method presented, this results in a particularly efficient and reliable method for location verification of installed cabin devices in an aircraft. For this purpose, the respective cabin devices can, for example, have corresponding QR codes so that a quick and reliable assignment is possible and the necessary configurations list can therefore be created.

### BRIEF DESCRIPTION OF THE DRAWINGS

The present invention is explained in more detail below with reference to the embodiments shown in the schematic figures:

FIG. 1 shows a schematic view of a verification unit according to an embodiment of the invention;

FIG. 2 shows a schematic view of an aircraft with a verification unit according to an embodiment of the invention;

FIG. 3 schematically depicts a flow diagram of a method for location verification of installed cabin devices in an aircraft single pair ethernet network using the verification unit of FIG. 1.

In the figures of the drawing, elements, features and components which are identical, functionally identical and of identical action are denoted in each case by the same reference designations unless stated otherwise.

### DETAILED DESCRIPTION OF THE PREFERRED EMBODIMENTS

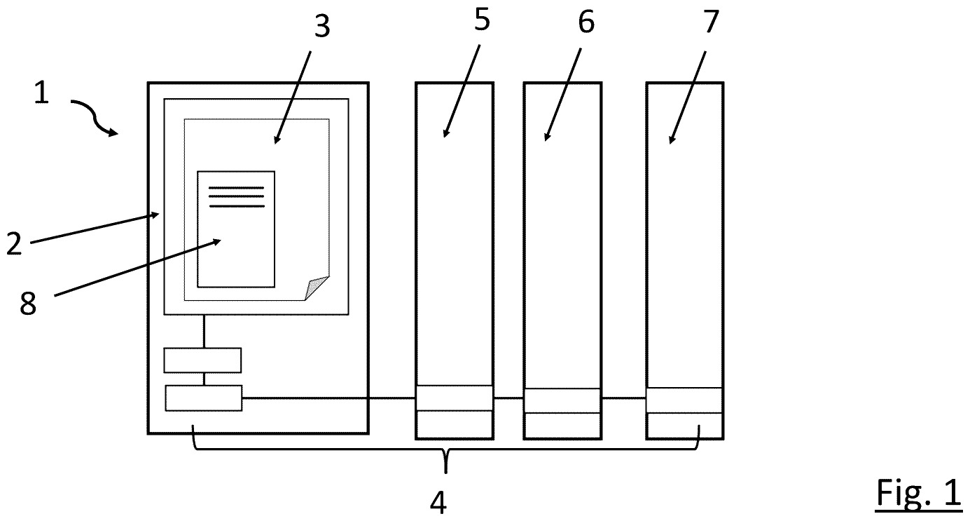

FIG. 1 shows a schematic view of a verification unit 1 according to an embodiment of the invention. The verification unit 1 is shown with a computer unit 2 with computer program 3. This computer unit 2 with computer program 3 is configured to provide a multidrop network architecture 4 for connecting a plurality of installed cabin devices 5, 6, 7 in an aircraft (not shown) to the computer unit 2 with computer program 3. The cabin devices can, for example, be respective line replaceable units or corresponding lighting devices in the cabin as well as in the cockpit or in the cargo area.

The computer unit 2 with computer program 3 is further configured to verify a respective location of the installed cabin devices 5, 6, 7 in an aircraft (not shown) depending on a comparison based on a configuration list 8 of the installed cabin devices 5, 6, 7 in the aircraft (not shown) stored in the computer program 3 and at least one connection routine of the multidrop network architecture 4.

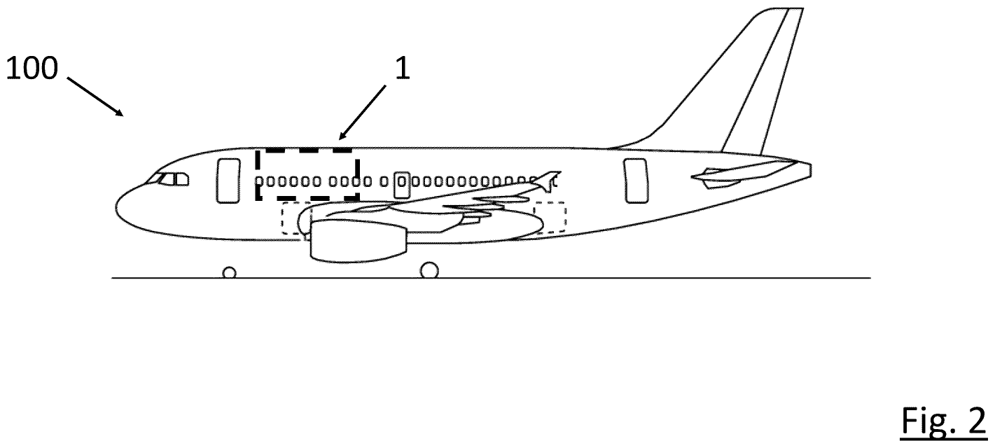

FIG. 2 shows a schematic view of an aircraft 100 with a verification unit 1 according to an embodiment of the invention.

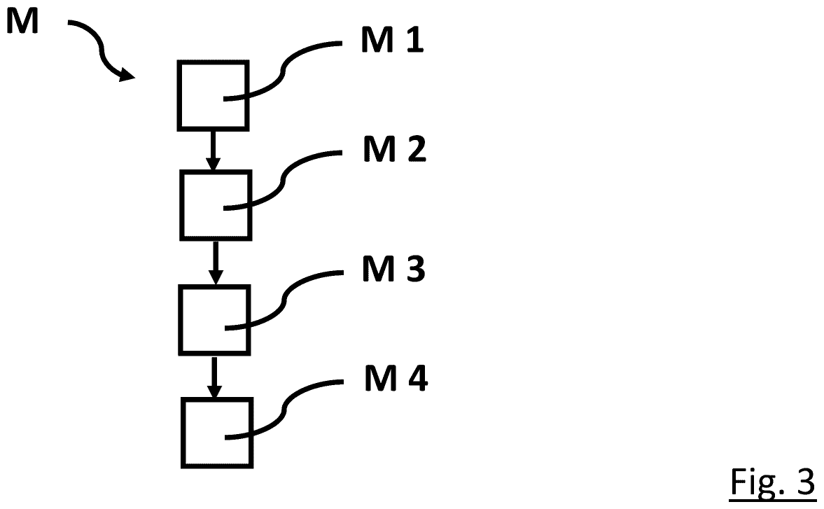

FIG. 3 schematically depicts a flow diagram of a method M for location verification of installed cabin devices 5, 6, 7 in an aircraft 100 single pair ethernet network using the verification unit of FIG. 1. This method M comprises under M1 providing and activating a verification unit 1 according to the invention. Furthermore, the method comprises under M2 creating and storing a configuration list of installed cabin devices 5, 6, 7 in an aircraft 100 on the computer program 3 of the verification unit 1. Furthermore, the method comprises under M3 performing a comparison based on the configuration list of the installed cabin devices 5, 6, 7 in the aircraft 100 stored in the computer program 3 and at least one connection routine of the multidrop network architecture of the verification unit 1. Furthermore, the method comprises under M4 outputting results of the comparison performed so that a respective location of the installed cabin devices 5, 6, 7 in the aircraft 100 can be verified.

In this respect, the presented method can also be referred to as an automatic localization method of multidrop participants that are connected to a certain or specified aircraft software platform.

In summary, the method could be also described in more detail as follows: A central controller (e.g. master unit) will be configured with a multidrop network attitude. The connected multidrop network participants will be sequentially requested and compared with a preloaded aircraft configuration list. If the following auto check can be seen as in accordance with basic requirements, an auto link procedure will be started with respective measurements of participants response times. The measures times reflect the distance of cable length (wire length) to participants and certain positions or positions sequences on the aircraft. Following an auto allocation will be activated and a final function test shows correct installation. Manual check might be necessary to verify the auto location method to ensure quality.

In a further detailed description, the method according to the invention could also be described in more detail as follows: In the final assembly line, each monument (cabin device) must be installed, including cabling and line replaceable unit, so that it is ready for the aircraft to be “turned on”. The final assembly line loads the expected configuration list on the installation device. This can also be done by scanning the respective QR codes. The aircraft receives its head of version configuration software load, which will be internally distributed to each master unit as a bus participant of a multidrop. Each master unit will start a network discovery mode to check the expected bus participants. When the automatic checklist is completed, the architecture discovery mode is started and each participant is logically linked to the predetermined installation order. Before the assignment list is to be finalized, a visual inspection with the support of the installation device (verification unit) is required to verificative the successful auto location method.

The application of the method is conceivable in the entire aircraft that allows the installation of ethernet technology (e.g., cabin, cargo and cockpit) not only in aircraft manufacturing but also in the case of retrofit.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 verification unit
2 computer unit
3 computer program
4 multidrop network architecture
5 cabin device
6 cabin device
7 cabin device
8 configuration list
100 aircraft
M method
M1-M4 method steps

1. A verification unit for location verification of installed cabin devices in an aircraft single pair ethernet network comprising:
a computer unit with computer program configured to provide a multidrop network architecture for connecting a plurality of installed cabin devices in an aircraft to the computer unit with the computer program,
wherein the computer unit is further configured to verify a respective location of the installed cabin devices in an aircraft depending on a comparison based on a configuration list of the installed cabin devices in the aircraft stored in the computer program and at least one connection routine of the multidrop network architecture.

2. The verification unit according to claim 1, wherein the at least one connection routine of the multidrop network architecture comprises an evaluation of a temporal transmission rate of transmission signals from the installed cabin devices to the computer unit.

3. The verification unit according to claim 1, wherein the configuration list comprises information about an installed order or cable lengths of cables between the installed cabin device and the computer unit.

4. The verification unit according to claim 1, wherein the computer unit is further configured to provide at least one alarm routine depending on at least one result of the comparison.

5. The verification unit according to claim 1, wherein the multidrop network architecture comprises at least one Single-Pair Ethernet, SPE, communication link for connecting the installed cabin devices in the aircraft to the computer unit.

6. A method for location verification of installed cabin devices in an aircraft single pair ethernet network, the method comprising:
providing and activating the verification unit according to claim 1;
creating and storing a configuration list of installed cabin devices in an aircraft on the computer program of the verification unit;
performing a comparison based on the configuration list of the installed cabin devices in the aircraft stored in the computer program and at least one connection routine of the multidrop network architecture of the verification unit; and,
outputting results of the comparison performed so that a respective location of the installed cabin devices in the aircraft can be verified.

7. The method according to claim 6, wherein the connection routine of the multidrop network architecture comprises an evaluation step of a temporal transmission rate of transmission signals from the installed cabin devices to the computer unit.

8. The method according to claim 6, wherein the configuration list comprises information about an installed order or a cable length of cables between the installed cabin devices and the computer unit.

9. The method according to claim 6, wherein the creating of the configuration list of the installed cabin devices in the aircraft is carried out by using additional tools.

10. An aircraft comprising:
the verification unit according to claim 1; and,
at least one installed cabin device connected to the verification unit via the multidrop network architecture of the verification unit.
